(19) United States
(12) Patent Application Publication
(10) Pub. No.: US 2013/0127881 A1
(43) Pub. Date: May 23, 2013

(54) SYSTEMS, DEVICES, AND METHODS FOR DRIVING A DISPLAY

(71) Applicant: QUALCOMM MEMS Technologies, Inc., San Diego, CA (US)

(72) Inventors: Alan Lewis, Sunnyvale, CA (US); Mark Todorovich, San Diego, CA (US); SuryaPrakash Ganti, Los Altos, CA (US); Koorosh Aflatooni, Cupertino, CA (US); Wilhelmus Johannes Robertus Van Lier, San Diego, CA (US); Kostadin Djordjev, San Jose, CA (US); Manu Parmar, Sunnyvale, CA (US); Jeho Lee, Palo Alto, CA (US)

(73) Assignee: QUALCOMM MEMS Technologies, Inc., San Diego, CA (US)

(21) Appl. No.: 13/672,489

(22) Filed: Nov. 8, 2012

Related U.S. Application Data
(60) Provisional application No. 61/558,991, filed on Nov. 11, 2011.

(51) Int. Cl. G09G 5/02; G09G 3/00; G06T 1/00

(52) U.S. Cl. CPC G09G 5/02; G06T 1/00; G09G 3/00
USPC 345/501; 345/690; 345/31

(57) ABSTRACT

This disclosure provides systems, methods and apparatus for writing data to a display. The frame rate is improved by simultaneously and independently writing data to multiple common lines of the display. In some implementations, lines of common color are written simultaneously. In some implementations, more common lines of lower visual importance are written simultaneously than common lines of higher visual importance. In these implementations, colors of higher visual importance can be displayed at a higher resolution to maintain good image quality while still improving frame rate. Display element electrodes may be coupled along common lines in various ways to implement simultaneous writing to multiple common lines.

### CROSS-REFERENCE TO RELATED APPLICATIONS

This disclosure claims priority to U.S. Provisional Patent Application No. 61/558,991, filed on Nov. 11, 2011, entitled “SYSTEMS, DEVICES, AND METHODS FOR DRIVING A DISPLAY,” and assigned to the assignee hereof. The disclosure of the prior application is considered part of, and is incorporated by reference in, this disclosure.

### TECHNICAL FIELD

This disclosure relates to methods and system for driving an array of display elements, such as an array of electromechanical display elements.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the tetin interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Interferometric modulators can be driven with a passive row and column driving scheme that writes image information sequentially into lines of display elements. To passively write data to a an array having rows and columns of display elements, each row of display may be addressed with a write pulse to write data to a display element according to segment data that is applied to the display element. In a sequential driving scheme, a frame rate for passively writing data to an array of display elements is a function of the number of separately addressed rows of display elements.

### SUMMARY

The systems, methods and devices of the disclosure each have several innovative aspects, no single one of which is solely responsible for the desirable attributes disclosed herein.

In one inventive aspect, a method of increasing the maximum frame rate of a display includes during a frame write process, simultaneously writing data to a first number of common lines associated with at least one color of lower visual importance, the at least one color of lower visual importance having a first resolution, and during the frame write process, simultaneously writing data to a second number of common lines associated with at least one color of higher visual importance, the at least one color of higher resolution having a second resolution that is greater than the first resolution. In this aspect, the first number is greater than the second number.

In another inventive aspect, a display apparatus includes an array of display elements formed at the intersection of a plurality of common lines and a plurality of segment lines. Each display element includes a display element segment electrode. A segment driver is connected to the plurality of segment lines and a common driver is connected to the plurality of common lines. A first linear density of display element segment electrodes are provided along a first common line and a second linear density of display element segment electrodes are provided along a second common line. The first linear density is less than the second linear density.

In another inventive aspect, an apparatus for increasing the maximum frame rate of a display includes means for simultaneously writing data to a first number of common lines associated with at least one color of lower visual importance during a frame write process, the at least one color of lower visual importance having a first resolution, and means for simultaneously writing data to a second number of common lines associated with at least one color of higher visual importance during the frame write process. The color of higher visual importance has a second resolution that is greater than the first resolution, and the first number is greater than the second number.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 is a block diagram illustrating examples of a column driver and a row driver for driving an implementation of an array of display elements.

FIG. 10 is a block diagram illustrating examples of a column driver and a row driver having at least some bifurcated segment lines for driving an implementation of an array of display elements.

FIG. 11 is a block diagram illustrating examples of a column driver and a row driver where the common electrodes are removed to illustrate the segment electrodes.

FIG. 12 is a cross sectional view of a display array showing connections between the electrical lines and the optical stacks of FIG. 11.

FIG. 13A is a block diagram illustrating examples of a an array having less row driver outputs than the number of rows in the array.

FIG. 13B is a block diagram illustrating examples of a column driver and a row driver having some bifurcated segment lines and bifurcated common lines for driving an implementation of an array of display elements.

FIG. 14 is a block diagram illustrating examples of a column driver and a row driver for driving an array of display elements including display elements having different areas along a row according to some implementations.

FIGS. 15A-15C illustrate cross sectional views of a display array, showing connections between the electrical lines and the optical stacks of adjacent display elements according to some implementations.

FIG. 16 is a block diagram illustrating examples of a column driver and a row driver for driving an array of display elements including display elements having different areas in different color rows according to some implementations.

FIG. 17 is a block diagram illustrating another example of a column driver and a row driver for driving an array of display elements including display elements having different areas in different color rows according to some implementations.

FIG. 18 is a block diagram illustrating another example of a column driver and a row driver for driving an array of display elements including an RGBG row pattern of display elements.

FIG. 19 is a block diagram illustrating another example of a column driver circuit 26 and a row driver for driving an array of display elements having a RGBG row pattern.

FIG. 20 is a block diagram illustrating another example of a column driver and a row driver for driving an array of display elements having a RGBG row pattern according to some implementations.

FIG. 21 is a block diagram illustrating another example of a column driver and a row driver for driving an array of display elements having a RGBG row pattern according to some implementations.

FIG. 22 illustrates a flowchart of a method for writing data to a display according to some implementations.

FIG. 23 illustrates another flowchart of a method for writing data to a display according to some implementations.

FIGS. 24A and 24B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

According to some implementations, a driving scheme for an array of display elements includes more segment lines than columns of display elements, and a reduced number of common driver outputs for driving common lines of the display. According to some implementations, rows of different colors having different levels of visual importance include display element segment electrodes having different size areas. In some implementations, each of the rows includes display elements having only one color, and multiple rows having the same color display elements are simultaneously and passively addressed using the same output from a common line driver.

Particular implementations of the subject matter described in this disclosure can be implemented to realize a reduction in the time required to write a frame of data to an array of display elements. Furthermore, for a given frame rate, it requires less power to write a frame of data to the display.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

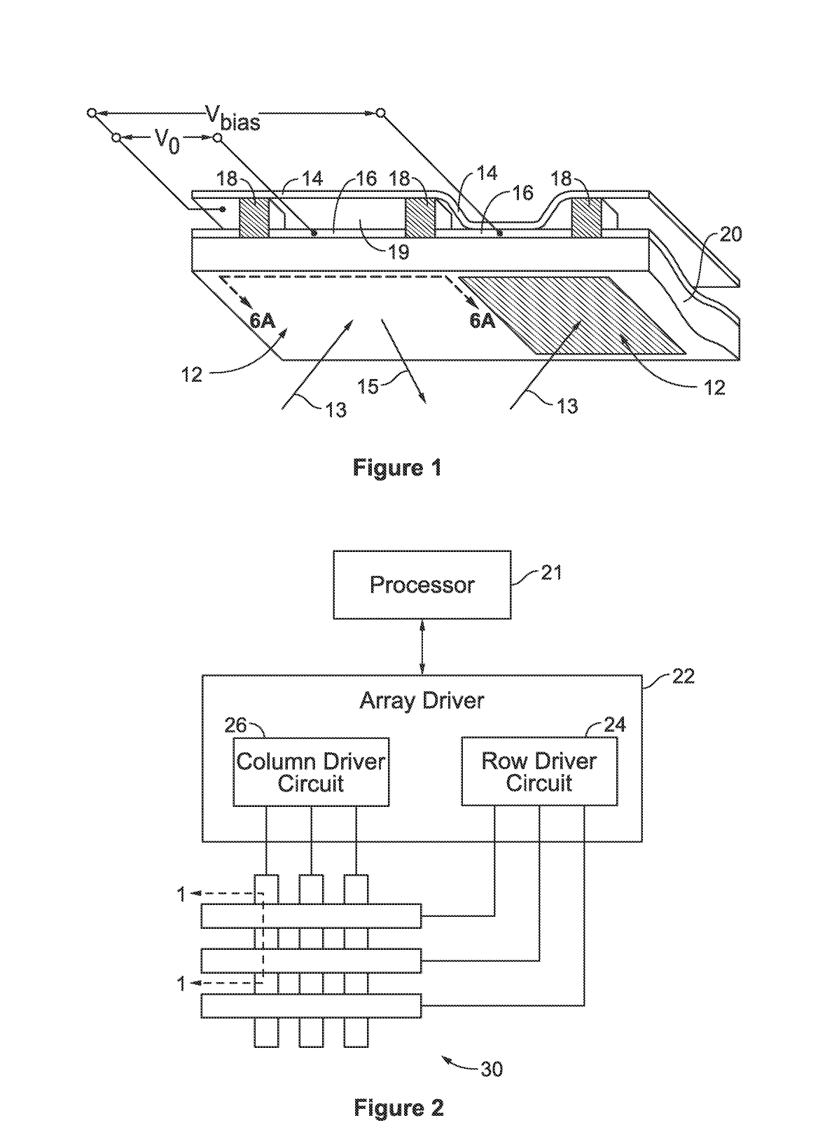

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

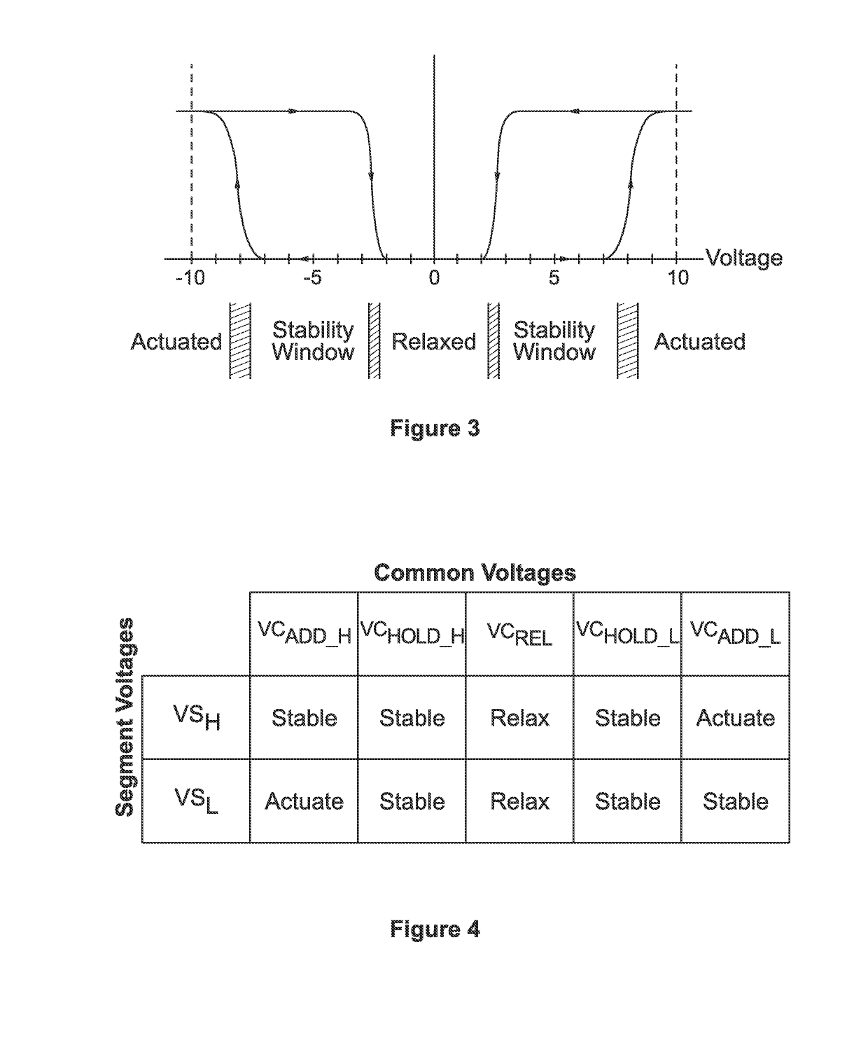

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, only pixels in the addressed row that are to be actuated are exposed to a voltage difference of about 10-volts. Pixels that are to be relaxed may be exposed to a voltage difference of near zero volts during the addressing period. In some implementations, as described further below, all pixels in the addressed row are exposed to a voltage difference of near zero volts prior to the addressing period, and then only those pixels to be actuated are exposed to a voltage difference above the actuation threshold, leaving the other pixels in their original relaxed state. After addressing, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

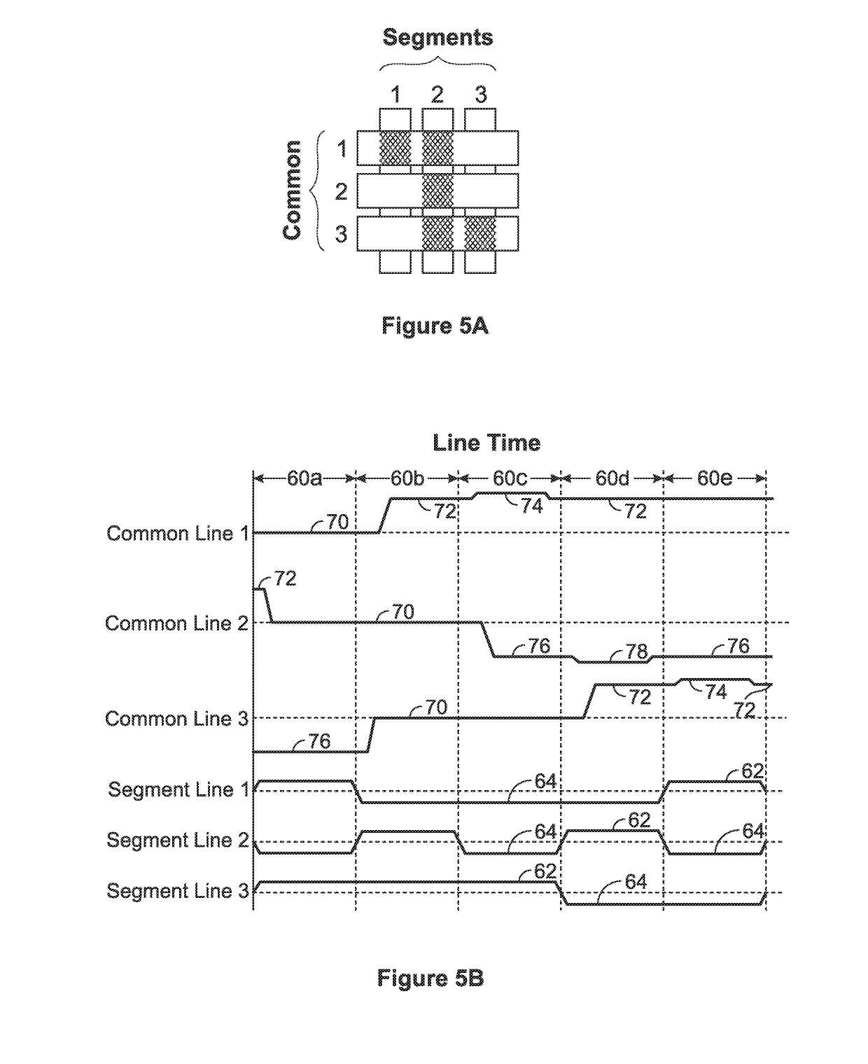

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L,} data can be selectively written to the modulators along that line by application of segment voltages along the respective segment lines. The segment voltages may be selected such that actuation is dependent upon the segment voltage applied. When an addressing voltage is applied along a common line that has previously experienced a clear cycle that released the display elements along the line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current released position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state.

With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. In some implementations, the release time is less than one line time. In implementations in which the release time of a modulator is very long, the release voltage may be applied for longer than a single line time, as depicted in FIG. 5B. In some other implementations, voltages applied along common lines or segment lines may vary to account for variations in the actuation and release voltages of different modulators, such as modulators of different colors. The waveforms shown in FIG. 5B are also not necessarily to the same relative scale. In some suitable implementations, the hold voltages 72 and 76 have a magnitude of about 10-20 volts, with the addressing voltage 74 adding about 3 to 5 volts onto that. The segment voltages 62 and 64 may have a magnitude of about 1 to 3 volts.

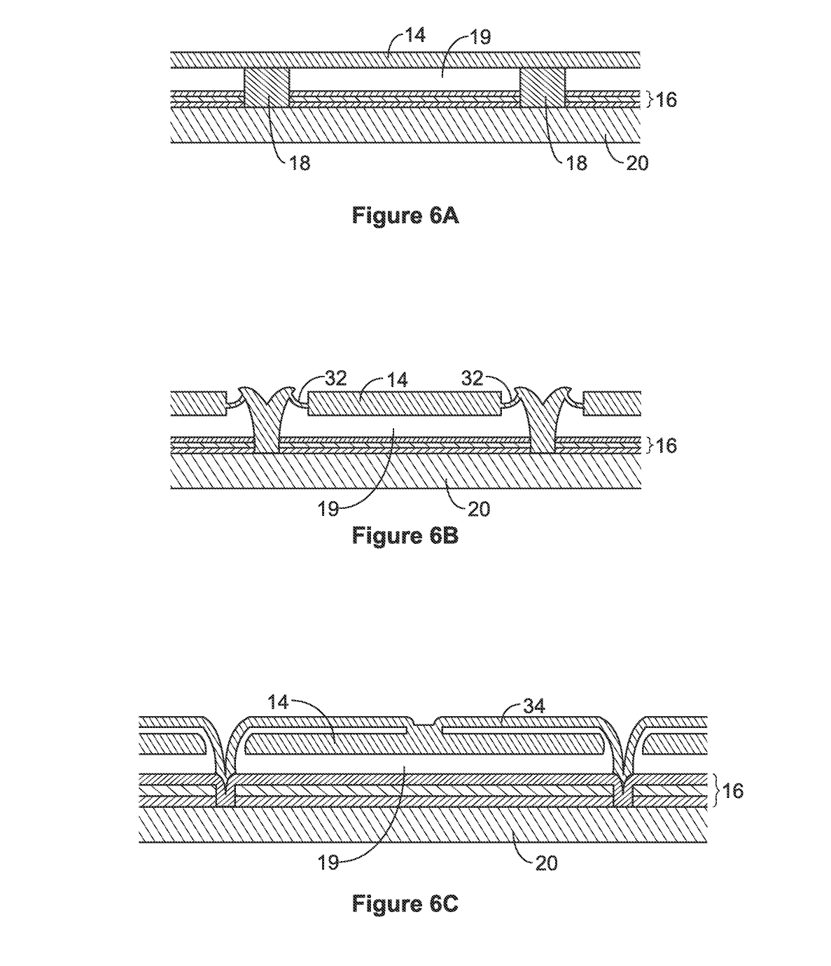

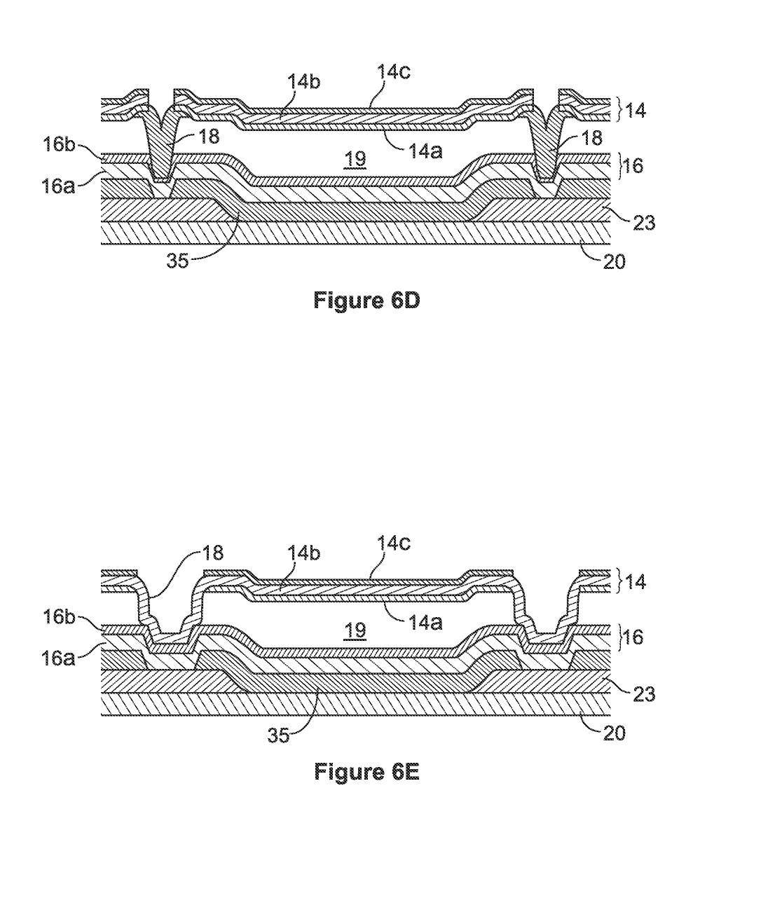

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 4a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a dielectric layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, one or more of the conductive layers can be used to transmit or bus signals between lower, stationary electrodes in the optical stack 16 of each row or column, or can be connected to the upper movable membrane. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

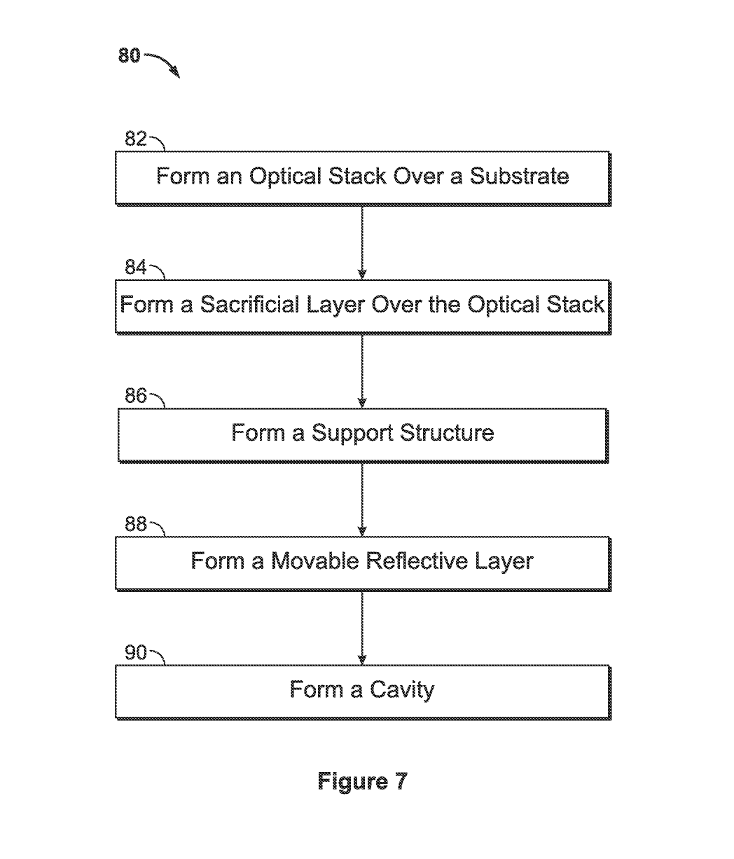

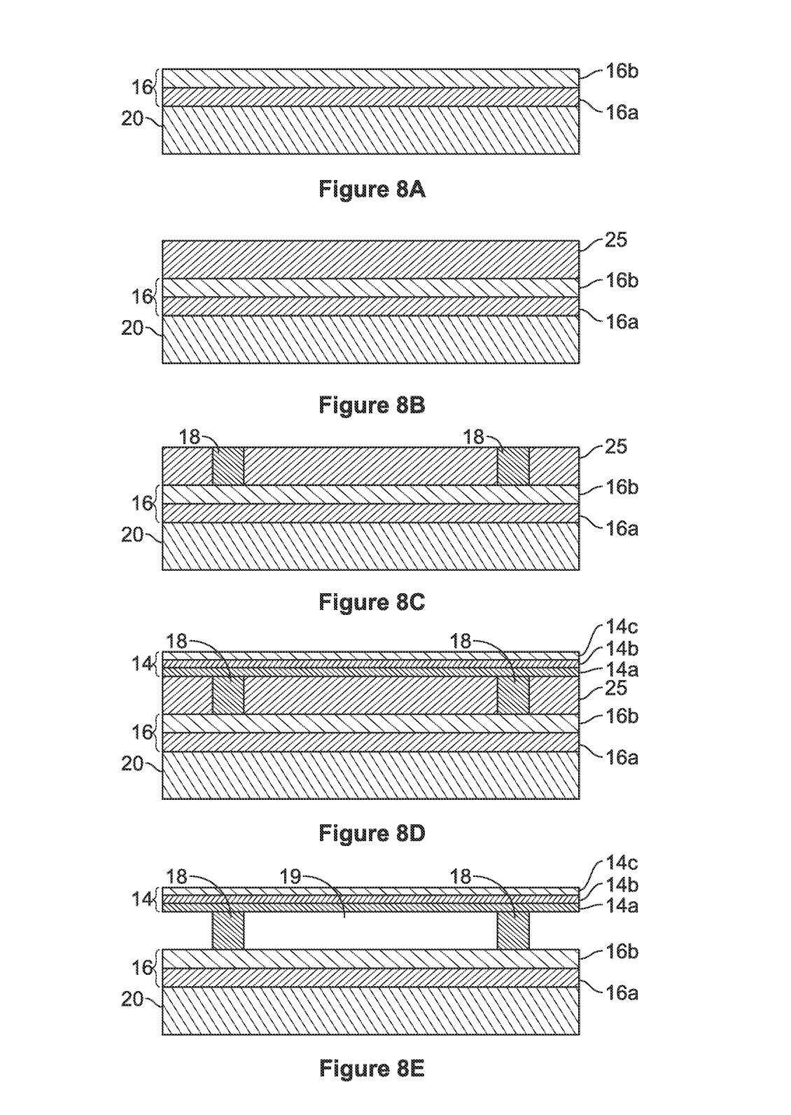

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

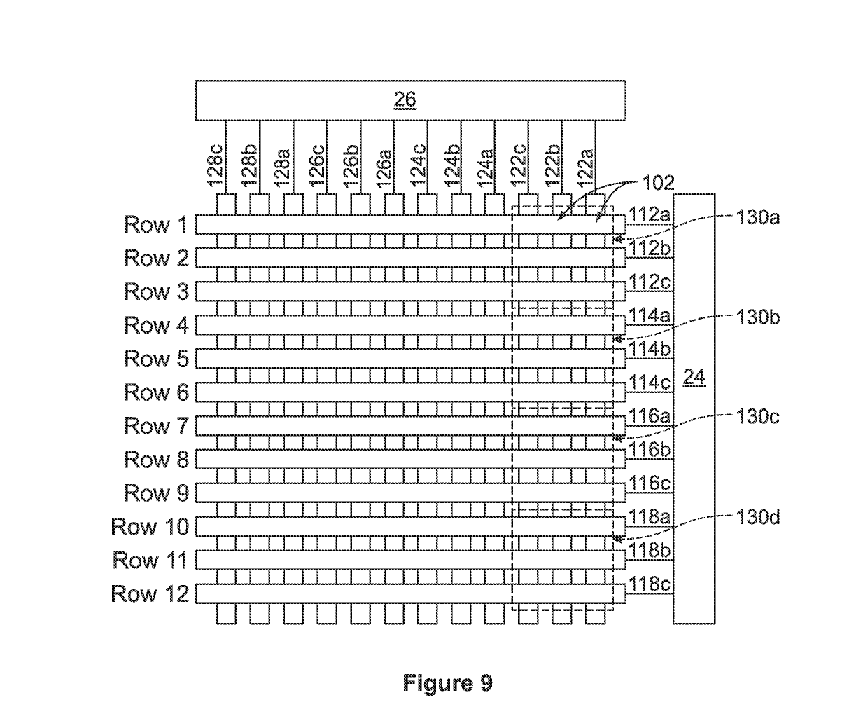

In certain displays, the number of physical display elements, such as, interferometric modulators, is greater than the number of pixels. The disparity may arise when multiple physical display elements are used for a single pixel in order to provide multiple colors or gray levels per pixel. An example of such a set up is shown in FIG. 9 which has pixels 130a-130d each of which are formed by a square array of nine physical display elements 102.

FIG. 9 is a block diagram illustrating examples of a column driver circuit 26 and a row driver circuit 24 for driving an implementation of an array of display elements 102. The array can include a set of electromechanical display elements 102, which in some implementations may include interferometric modulators. A set of segment lines 122a-122c, 124a-124c, 126a-126c, and 128a-128c may be connected to a set of segment electrodes of the array. A set of common lines 112a-112c, 114a-114c, 116a-116c, and 118a-118c may be connected to a set of common electrodes of the array. The segment lines 122a-122c, 124a-124c, 126a-126c, and 128a-128c and common lines 112a-112c, 114a-114c, 116a-116c, and 118a-118c can be used to address the display elements 102, as each display element 102 will be in electrical communication with a segment electrode and a common electrode. In the following description, the column driver circuit 26 will be described as a segment driver configured to drive a plurality of segment lines, while the row driver circuit 24 will be described as a common driver configured to drive a plurality of common lines. The operation of the column driver circuit 26 and the row driver circuit 24 is not limited thereto. For example, the column driver circuit 26 may be configured as a common driver to drive a plurality of common lines, while the row driver circuit 24 may be configured as a segment driver to drive a plurality of segment lines. In the implementation of FIG. 9, the column driver circuit 26 is configured to apply voltage waveforms to each of the segment electrodes of the array of display elements, and the row driver circuit 24 is configured to apply voltage waveforms to each of the common electrodes of the array of display elements.

In one driving scheme, display data is provided to each segment line according to the desired data state for a row of display elements. A write pulse is then applied to a single common line to update the display elements 102 in that row. In the display driving scheme of FIG. 9, if there are M columns of display elements 102, the column driver circuit 26 will have M outputs. Similarly, if the there are N rows of display elements 102, the row driver circuit 24 will have N outputs. In terms of pixels having a 9 (3 by 3) sub-pixel architecture, for an array with M columns of display elements 102 and N rows of display elements 102, there will be M/3 columns of pixels, and N/3 rows of pixels.

Still with reference to FIG. 9, in an implementation in which the display includes a color display or a monochrome grayscale display, the individual display elements 102 may correspond to subpixels of larger pixels. Each of the pixels may include some number of subpixels. In an implementation in which the array includes a color display having a set of interferometric modulators, the various colors may be aligned along common lines (or rows as illustrated in FIG. 9), such that substantially all of the display elements 102 along a given common line include display elements 102 configured to display the same color. Some implementations of color displays include alternating rows of red, green, and blue subpixels. For example, lines 112a, 114a, 116a, and 118a may correspond to rows of red display elements 102, lines 112b, 114b, 116b, and 118b may correspond to rows of green display elements 102, and lines 112c, 114c, 116c, and 118c may correspond to rows of blue display elements 102. In one implementation, each 3×3 array of interferometric modulators 102 forms a pixel such as pixels 130a-130d as illustrated in FIG. 9.

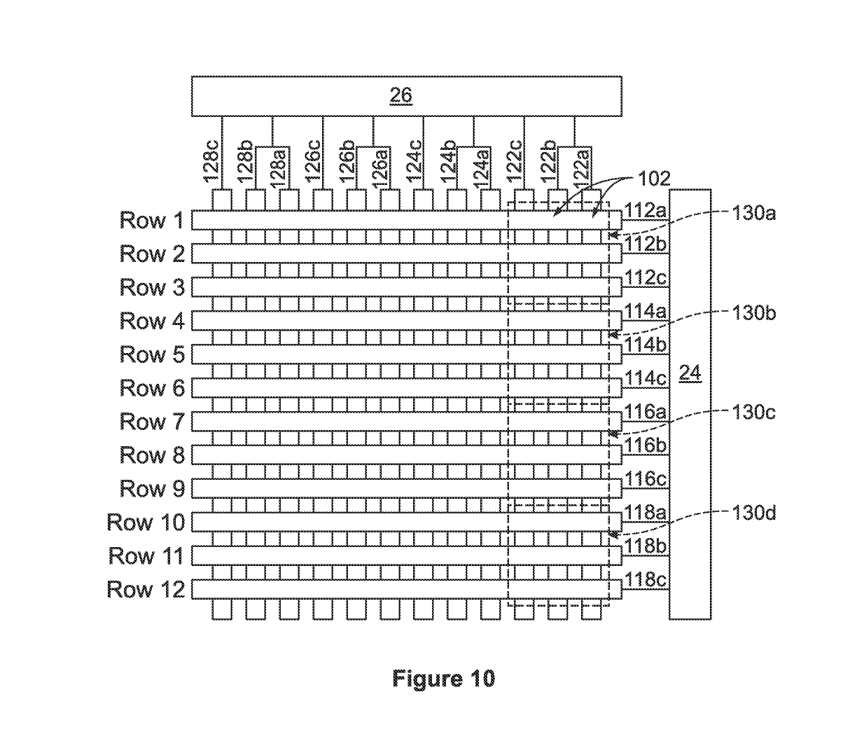

In some implementations, some of the electrodes may be in electrical communication with one another. FIG. 10 is a block diagram illustrating examples of a column driver circuit 26 and a row driver circuit 24 having at least some bifurcated segment lines for driving an implementation of an array of display elements 102. For example, as illustrated in FIG. 10, segment lines 122a and 122b are connected to one-another, such that the same voltage waveform can be simultaneously applied to each of the corresponding segment electrodes connected to segment lines 122a and 122b. In the illustrated implementation of FIG. 10 in which two of the segment electrodes are shorted to one another, a 3×3 pixel will be capable of rendering 64 different colors (e.g., a 6-bit color depth), because each set of three common color display elements 102 in each pixel can be placed in four different states, corresponding to none, one, two, or three actuated display elements 102 (such as interferometric modulators). When using this arrangement in a monochrome grayscale mode, the state of the three pixel sets for each color are made to be identical, in which case each pixel can take on four different gray level intensities. It will be appreciated that this is just one example, and that larger groups of display elements 102 may be used to form pixels having a greater color range with different overall pixel count or resolution.

Because it is coupled to two segment electrodes, the column driver circuit 26 outputs connected to two segment electrodes may be referred to herein as a “most significant bit” (MSB) segment output since the state of this segment output controls the state of two adjacent display elements 102 in each row. Column driver circuit 26 outputs coupled to individual segment electrodes such as at 126c may be referred to herein as “least significant bit” (LSB) segment output since they control the state of a single display element 102 in each row.

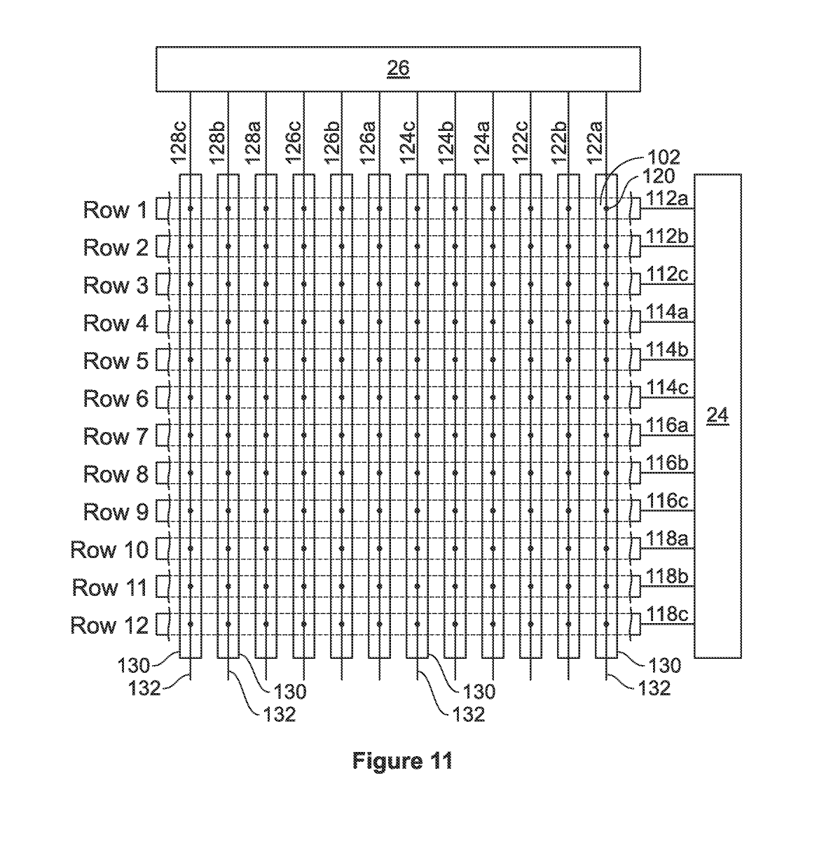

In the array of FIGS. 9 and 10, the row driver circuit 24 has a set of outputs that are connected to common electrodes that extend horizontally in FIGS. 9 and 10 as parallel strips. The column driver circuit 26 has a set of outputs that are connected to segment electrodes that extend vertically in FIGS. 9 and 10 as parallel strips beneath the common electrodes. FIG. 11 is a block diagram illustrating examples of a column driver circuit 26 and a row driver circuit 24 where the common electrodes are shown only in phantom with dotted lines on their sides to illustrate the segment electrodes 130. As illustrated in FIG. 11, the center portions of the common electrodes are illustrated as transparent for clarity of illustration to make the segment electrodes 130 visible.

According to some implementations, when the display elements 102 are formed as interferometric modulators, the segment electrodes 130 can be deposited layers of a conductive metal (such as chromium) on a substrate (such as glass). The common electrodes may be formed as strips of conductive metal (such as aluminum) suspended on posts over the deposited segment electrode strips. In some implementations, while not illustrated, the segment electrodes may instead be formed as strips suspended on the posts over the deposited common electrode strips. As discussed above, display elements 102 are defined by the regions of adjacent segment electrode and common electrode at the intersection points of the strips. The row driver circuit 24 and column driver circuit 26 apply voltages to the strips with a timing and magnitude to passively address the display elements 102 by selectively collapsing and releasing the display elements 102 to display an image. As described herein, passive addressing refers to directly coupling a driving signal from an output of a driver to a display element, without intermediate isolation using switches (such as transistors) or other devices.

While the segment lines in FIGS. 9 and 10 are shown to be connected to the ends of the segment electrodes, the thin conductive metal layer (such as chromium) of the segment electrodes may not be as conductive as desired for driving the display. The configuration in FIG. 11 illustrates an arrangement where the segment electrodes 130 are connected to the column driver circuit 26 by highly conductive segment lines (such as segment line buses 132) that run underneath the segment electrodes. The segment electrodes are then connected through vias 120 to the segment lines at each point corresponding to a display element 102 as illustrated by the black circles in FIG. 11. To make these segment lines (which are generally opaque) invisible to a user of the display, they are typically relatively narrow so as to not restrict the aperture ratio, and can be routed over or be formed as the black mask structures described above.

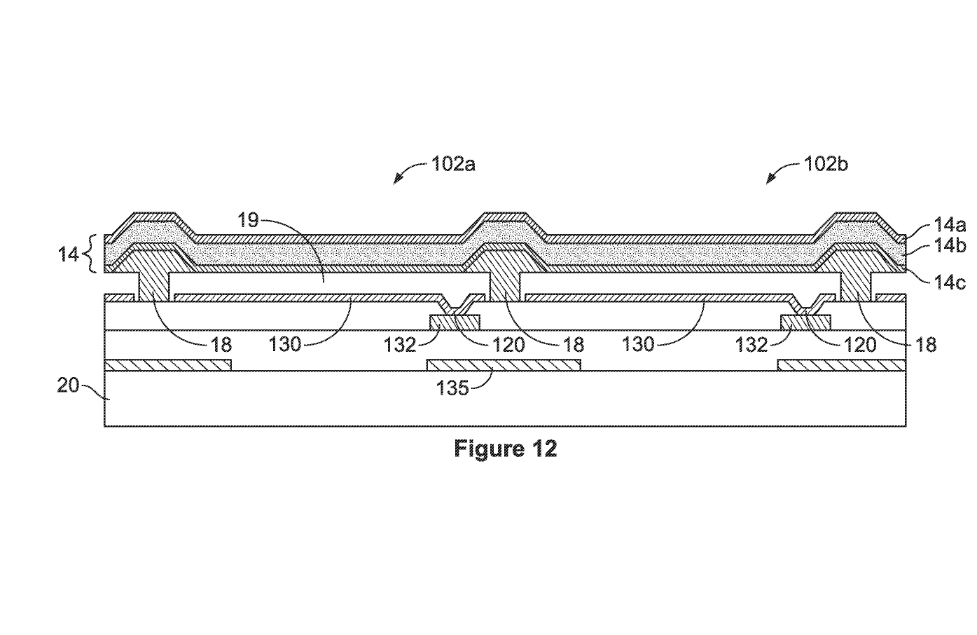

FIG. 12 is a cross sectional view of a display array, showing connections between the segment line buses 132 and the segment electrodes 130 of FIG. 11. FIG. 12 illustrates a cross-section of two adjacent display elements 102a and 102b of the array of display elements illustrated in FIG. 11 with the movable membrane 14 supported by by support structures 18 which may be at the corners of each display element. In the array of FIG. 11, the strip segment electrodes are illustrated as strips of conductive material that run vertically down the page. In the cross-section of FIG. 12, the strip segment electrodes 130 may be formed as part of the optical stack 16 deposited on the substrate 20. Beneath and between the segment electrodes 130 are the segment line buses 132. The strips of conductive material forming common electrodes running perpendicular to and above the segment electrodes 130 and left to right in the page as illustrated in FIG. 11 correspond to the conductive layers 14c of the display elements 102a and 102b. As illustrated in FIG. 12, the segment electrodes 130 are connected to the segment line buses 132 through the vias 120. Because the segment line buses 132 can be made thicker and of a higher conductivity material than the segment electrodes, an RC time constant of the load on the segment driver (e.g. column driver circuit 26 of FIG. 11) can be reduced. As a result, an optical stack 16 including the segment electrode 130 may respond faster to voltage changes applied by the column driver circuit 26 through the segment line buses 132. The structures described above are deposited on the transparent substrate 20 through which the display is viewed. Black mask strips 135 may be used so that the segment lines 132 and support structures 18 are invisible to the user.

The segment electrodes of FIGS. 9, 10, and 11 are continuous strips which extend all the way down a column of display elements 102. Data may be written to each row of the display separately by simultaneously applying a set of data signals to each of the segment electrodes, and then providing a write signal from the row driver circuit 24 to a particular row being written. This will write the data corresponding to the applied column driver circuit 26 outputs along that row without affecting the other rows. Thus, a separate independent row driver circuit 24 output is provided for each row of display elements. In the configuration of FIGS. 9-11, if multiple rows are connected to the same row driver circuit 24 output, the multiple rows would all be written with the same data that was being output by the column driver circuit at the time the row driver circuit 24 output was applied to the multiple rows.

As described above, to write data to the display, the column driver circuit 26 may apply voltages to the segment electrodes or buses along a row of display elements 102 connected to a common line. Thereafter, the row driver circuit 24 may pulse a selected common line connected thereto to cause the display elements 102 along the selected line to display the data, for example by actuating selected display elements 102 along the line in accordance with the voltages applied to the respective segment outputs. After display data is written to the selected line, the column driver circuit 26 may apply another set of voltages to the buses connected thereto, and the row driver circuit 24 may pulse another line connected thereto to write display data to the other line. By repeating this process, display data may be sequentially written to any number of lines in the display array. The time required to write a frame of data for the display therefore corresponds to the time required to write one row times the number of rows.

Therefore, the time of writing display data (a.k.a. the frame write time) to the display array using the above described driving scheme is generally proportional to the number of lines of display data being written. In many applications, it is advantageous to reduce the frame write time to increase the frame rate of a display or to smooth the appearance of moving video images, for example.

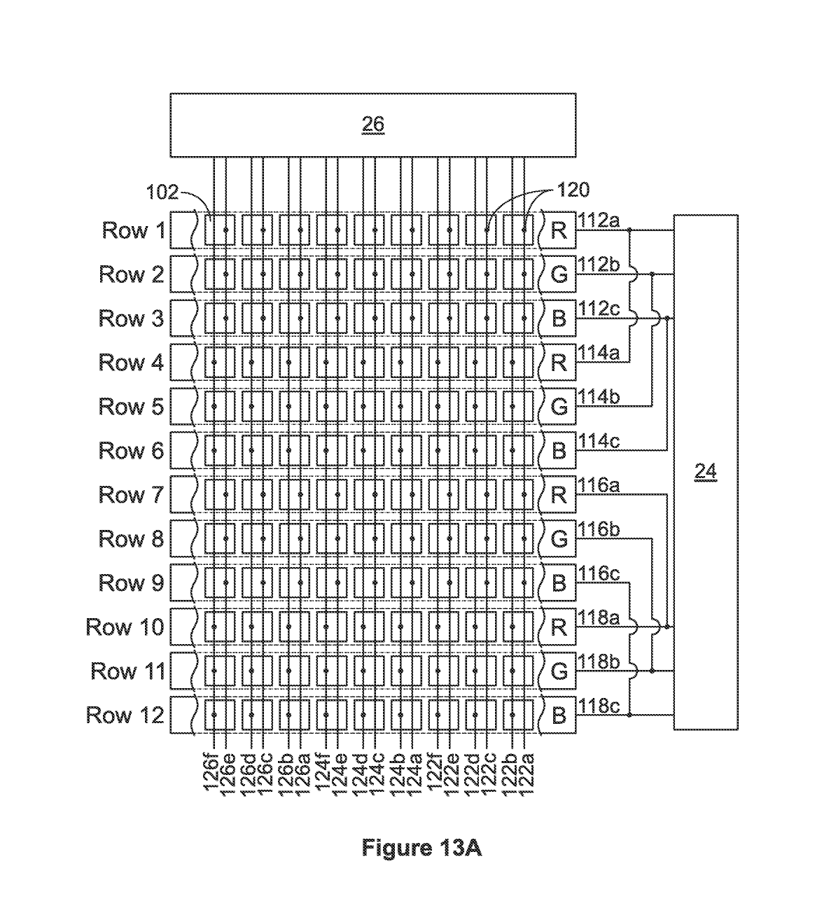

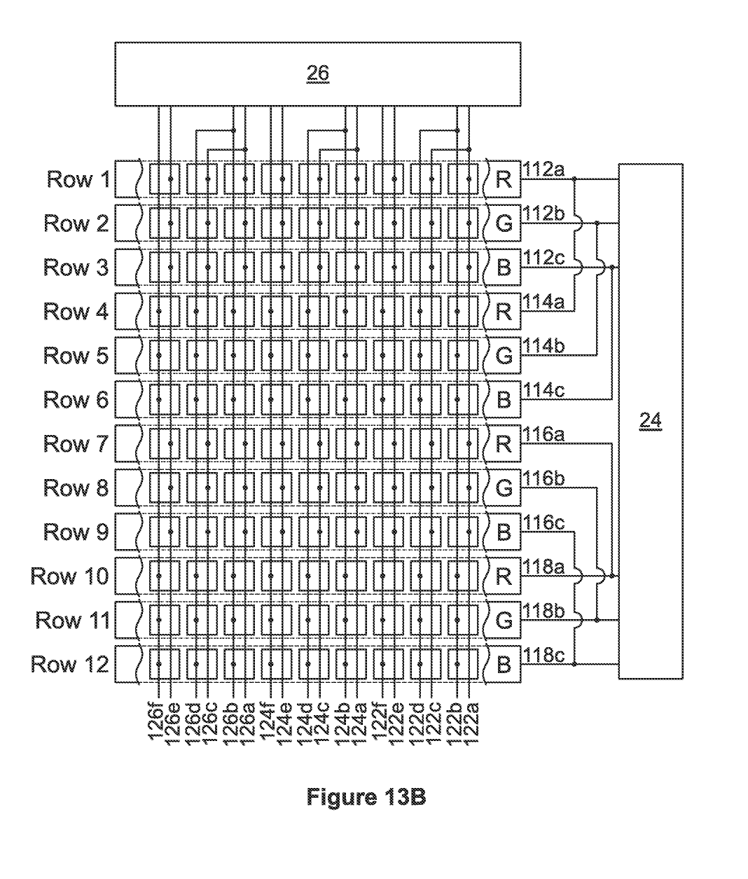

FIG. 13A is a block diagram illustrating examples of an array having fewer row driver circuit 24 outputs than the number of rows in the array. As illustrated in FIG. 13A, the array includes rows having only a single color. The pattern of colors repeats such that a first row includes only red display elements 102, a second row includes only green display elements 102, and a third row includes only blue display elements 102, with the second row being disposed between the first row and the third row. The pattern repeats such that the array has an RGB pattern of rows of display elements 102. Further, each row of display elements 102 is separated from an adjacent row of display elements 102 along the direction of the segment lines. The display element segment electrodes of FIG. 13A are not connected to each other along the segment line direction, except where connections from the display element segment electrodes are made to the same segment line through the vias 120. Because the display element segment electrodes are no longer connected vertically between every row of display elements, additional outputs of the column driver circuit 26 can be provided to provide data simultaneously to multiple rows of display elements 102. This can allow simultaneous and independent data writing to two or more rows. In FIG. 13A, two segment lines per column of display elements are shown, but three, four, or any number may be provided to write three, four, or any number of common lines simultaneously.

In the implementation illustrated in FIG. 13A, the column driver circuit 26 includes twice as many outputs as columns of display elements 102. The row driver circuit 24 includes bifurcated outputs, such that two rows having the same color of display elements are driven by a single output of the row driver circuit 24 (e.g., through a single row driver output). For example, common lines 112a and 114a may each correspond to the same common line output from the row driver circuit 24. Similarly, common lines 112b and 112c may be connected to common lines 114b and 114c, while common lines 116a, 116b, and 116c, may be connected to common lines 118a, 118b, and 118c, respectively as shown in FIG. 13A. Throughout the various implementations described herein, including the implementations of FIGS. 13A-13B, 14, and 16-21, simultaneously addressed rows are described with respect to rows of the same color. Addressing rows of the common color may provide a variety of significant advantages. For example, the voltage levels output from the common driver circuit may be different for different color rows of display elements. Writing common color rows simultaneously can therefore simplify power supply and driver electronics. However, a person having ordinary skill in the art will recognize that non-common color rows may also be addressed simultaneously using the same row driver output 24.

Since each display element 102 may be connected to one of two segment lines, and since the display element segment electrodes corresponding to each of the display elements 102 are not connected to each other, display elements 102 in different rows may be written with different data using the same common line driving signal. That is, for a given row, each display element 102 includes a discrete connection to one of the segment lines as illustrated by vias 120 of FIG. 13A. For example, as illustrated in

FIG. 13A, Row 1 having red display elements 102 may have display elements 102 with connections to segment lines 122a, 122c, 122e, 124a, 124c, 124e, 126a, 126c, and 126e. Row 4, also having red display elements 102, includes display elements 102 which are connected to segment lines 122b, 122d, 122f, 124b, 124d, 124f, 126b, 126d, and 126f. Therefore, a common line write signal applied to both Rows 1 and 4 is configured to write different data to the display elements in each row based on the segment line data provided to each display element 102 in each row.

Thus, where the display of FIG. 11 had N row driver circuit 24 outputs (one for each row of display elements 102) and M column driver circuit 26 outputs (one for each column of display elements), the display in the configuration of FIG. 13A has 2M column driver circuit 26 outputs and N/2 row driver circuit 24 outputs. This is a result of sharing of each row driver circuit 24 output with a pair of rows having the same color display elements 102. As previously noted, in the implementation in which the row driver circuit 24 is configured as the common driver for driving the common lines, the frame time increases proportionally (resulting in a decreased frame rate) with the number of row driver circuit 24 outputs. While the number of column driver circuit 26 outputs in the arrangement of FIG. 13A has increased relative to the array of FIG. 11, the number of row driver circuit 24 outputs has decreased. The reduced number of independently addressed rows results in a decrease in frame time. Further, the resolution of the display is the same in FIG. 13A as it is in FIG. 11, so there is no visual impact to driving the display as shown in FIG. 13A as opposed to FIG. 11. It will be appreciated that the total number of outputs of the common driver circuit 24 can still be the same as the total number of rows, but in that case, multiple outputs of the common driver circuit 24 can be asserted at the same time. This still results in multiple rows being written simultaneously with the resulting improvement in frame rate.

Similar to the implementation discussed above with respect to FIG. 10, some of the display element segment electrodes of FIG. 13A may also be in electrical communication with one another. FIG. 13B is a block diagram illustrating examples of a column driver circuit 26 and a row driver circuit 24 having some bifurcated segment lines and bifurcated common lines for driving an implementation of an array of display elements 102. In the implementation of FIG. 13B, a pixel may correspond to a 3×3 section of three red display elements, three green display elements, and three blue display elements. This allows two bits per color color depth for each pixel. In this implementation, two display elements of the same color may be driven with the same segment output from the segment driver 26, while still allowing each color portion of each pixel to have one, two, or three display elements actuated. The pair of display elements driven with the same output are referred to as the most significant bit (MSB) of that pixel, and the corresponding segment output is referred to as an MSB output. As illustrated in FIG. 13B, an MSB segment output of the column driver circuit 26 is connected to bifurcated segment lines connected to two columns of the array of display elements, while an LSB segment output of the column driver circuit 26 is connected to a single segment line. For example, segment lines 122a and 122c are connected to one-another and to an MSB segment output of the column driver circuit 26, such that the same voltage waveform can be simultaneously applied to each of the corresponding display element segment electrodes connected to segment lines 122a and 122c. Display element segment lines 122b and 122d are also connected to one-another and to another MSB segment output of the column driver circuit 26. Segment lines 122e and 122f are individually connected to LSB segment outputs of the column driver circuit 26. Similar to the display of FIG. 13A, the display of FIG. 13B includes twice as many segment lines as columns of the display elements 102, but includes a reduced number of column driver circuit 26 outputs relative to the implementation of FIG. 13A due to the MSB/LSB configuration.

As discussed above with reference to FIG. 13A, the array also includes bifurcated common lines for writing data to the array. Similar to the implementation of FIG. 10, in the illustrated implementation of FIG. 13B in which two of the display segment lines are shorted to one another, a 3×3 pixel will be capable of rendering 64 different colors (e.g., a 6-bit color depth), because each set of three common color display elements 102 in each pixel can be placed in four different states, corresponding to none, one, two, or three actuated display elements 102 (such as interferometric modulators). Further, similar to the implementation of FIG. 13A, data may be simultaneously written to two rows of the same color, thereby reducing the frame rate of the display. That is, through application of a common line driving signal to a bifurcated row driver circuit 24 output connected to two common lines of different rows of display elements 102, two rows of the same color may be written simultaneously with data.

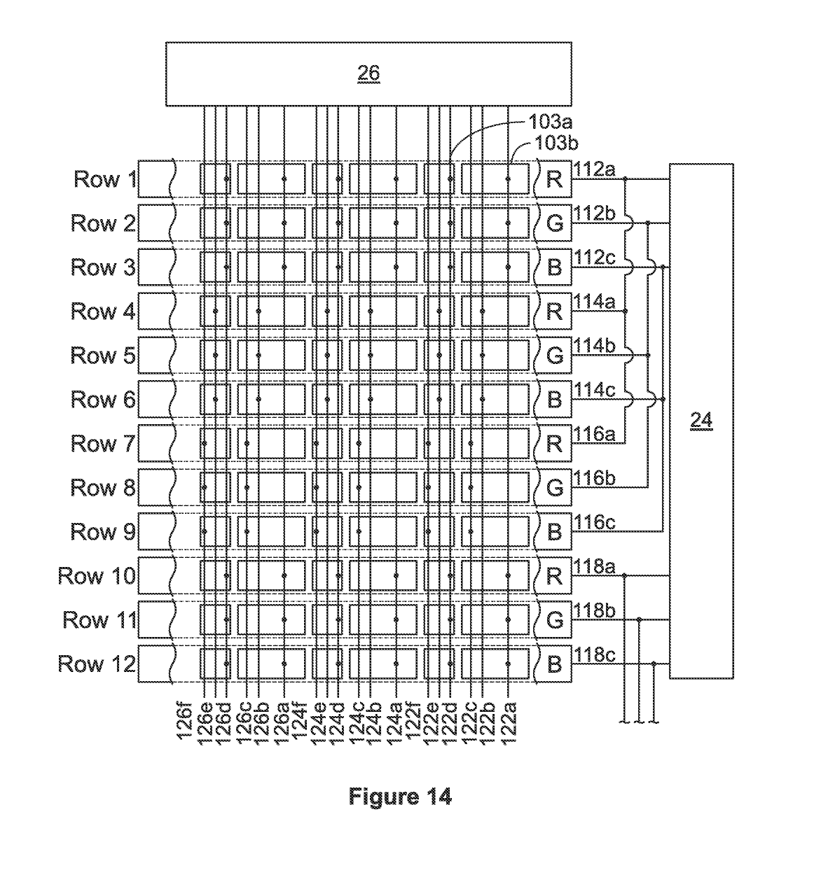

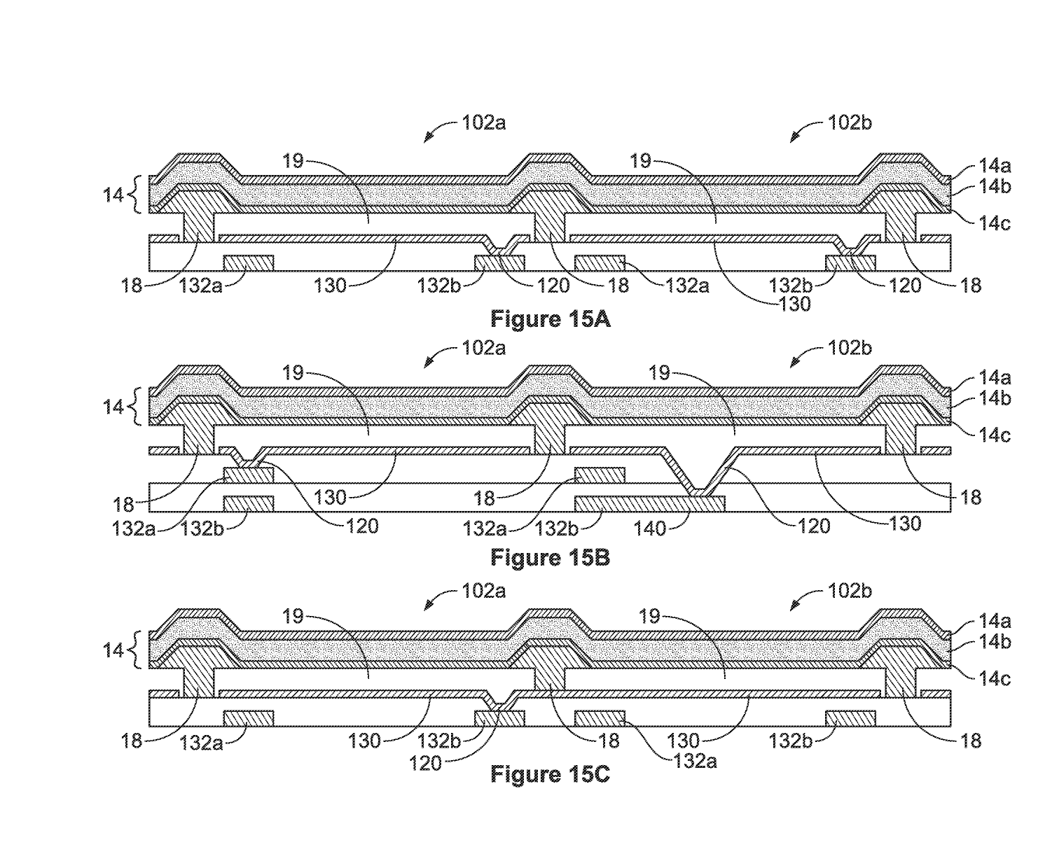

According to some implementations, segment electrodes in display elements of a row may have different size areas, or may be electrically connected, so that even more than two rows can be written simultaneously with data. FIG. 14 is a block diagram illustrating examples of a column driver circuit 26 and a row driver circuit 24 for driving an array of display elements 102 including display elements 102 with display element electrodes having different areas along a row according some implementations. In FIG. 14, a “column” of display elements is still defined by the width of the thinnest segment electrode along the common lines. Thus, FIG. 14 is considered to have nine “columns” of display elements just like FIGS. 13A and 13B. Although shown with display element electrodes having different areas such that the electrical connection along the common line is provided by the segment electrode material itself, in some implementations, it is understood that adjacent display element electrodes may be simply electrically connected to each other or ganged with a separate bus line or deposited conductive coupling to provide for a similar functionality. As illustrated in FIG. 14, each row of display elements 102 includes display elements 103a with a display element segment electrode having a first area and display elements 103b with a display element segment electrode having a second area that is larger than the first area. This produces a lower linear density of segment electrodes along these common lines, where the linear density of segment electrodes is defined as the number of separate segment electrodes per unit length such as per centimeter or per inch along the common line. The display elements 103b may be configured as two of display elements 103a having coupled display element segment electrodes as will be described in greater detail with reference to FIG. 15C below. In the different rows, the display elements 103b may be connected to one of three segment lines. For example, display element 103b of Row 1 is connected to segment line 122a. The corresponding display element in Rows 4 and 7 are connected to segment lines 122b and 122c respectively. Further, display element 103a of Row 1 is connected to segment line 122d, while corresponding display elements in Rows 4 and 7 are connected to segment lines 122e and 122f respectively.

Since each of the display elements in each row may be connected to one of three segment lines, three rows of display elements of the same color may be written simultaneously using one row driver output connected to three common lines. For example, as illustrated in FIG. 14, Rows 1, 4, and 7 having red display elements may be written simultaneously using common lines 112a, 114a, and 116a connected to the same row driver circuit 24 output. Similarly, Rows 2, 5, and 8 having green display elements may be written simultaneously, and Rows 3, 6 and 9 may be written simultaneously. The implementation of FIG. 14 can independently write different image data to three common lines simultaneously with 18 segment lines rather than only two as in FIG. 13A due to the reduced linear density of segment electrodes along the common lines in FIG. 14 as compared to FIG. 13A.

FIGS. 15A-15C illustrate cross sectional views of a display array, showing connections between the segment lines and the display element segment electrodes 130 of adjacent display elements 102a and 102b according to some implementations. In these Figures, the substrate 20 and associated black mask 135 of FIG. 12 are omitted. The structure of FIG. 15A may correspond to, for example, two adjacent display elements 102 along the same row as discussed above with reference to FIGS. 13A and 13B. As illustrated in FIG. 15A, each display element 102a and 102b includes two segment lines traversing below the display element segment electrode 130 as illustrated by segment lines buses 132a and 132b. For example, segment line buses 132a and 132b traversing display element 102b may correspond to buses that traverse a display element such as, for example, segment lines 122a and 122b of FIGS. 13A and 13B, while segment line buses 132a and 132b traversing display element 102a may correspond to segment lines 122c and 122d of FIGS. 13A and 13B. Display elements 102a and 102b are connected to a segment line bus 132b. Other display elements in different rows of the array may have display element segment electrodes 130 that are connected through vias 120 to segment line bus 132a.

According to some implementations, as illustrated in FIG. 15B, segment line buses 132a and 132b traversing beneath the display element segment electrodes of each display element 102a and 102b may be stacked vertically. That is, as illustrated, a first segment line bus 132a may be formed below the display element segment electrode 130, while a second segment line bus 132b may be formed substantially directly below the first segment line bus 132a. As illustrated, display element 102a may be connected to the segment line bus 132a through via 120. Display element 102b may be connected to the segment line bus 132b through via 120 and connection terminal 140. The structure of the connection terminal 140 connects a via 120 to the second segment line bus 132b. The location and size of the connection structure 140 and the segment line buses 132a and 132b as illustrated is exaggerated for ease of description. In some implementations, the width of each display element is substantially greater than the width of the segment line buses 132, and the segment line buses 132 are positioned near the posts 18 of each of display elements 102 and away from the center of the display elements 102.

According to some implementations, two adjacent display elements 102a and 102b may have coupled display element segment electrodes. For example, as illustrated in FIG. 15C, the optical stacks 16 of display elements 102a and 102b which includes the display element segment electrodes of each display element 102a and 102b may be connected to each other. In some implementations, this connection may be made during manufacturing of the display elements 102a and 102b by not patterning the display element segment electrode 130 in the area below the central post 18. The display elements 102a and 102b having a coupled segment electrode may correspond to, for example, the second display element 103b as discussed above with reference to FIG. 14. The structure of FIG. 15C allows a single connection (such as via 120 of FIG. 15C) to one segment line to be used to drive display element 102a and display element 102b simultaneously.

A person having ordinary skill in the art will recognize that the structures illustrated in FIGS. 12, and 15A-15C may correspond to any number of implementations of arrays of display elements discussed throughout the description of the various figures.

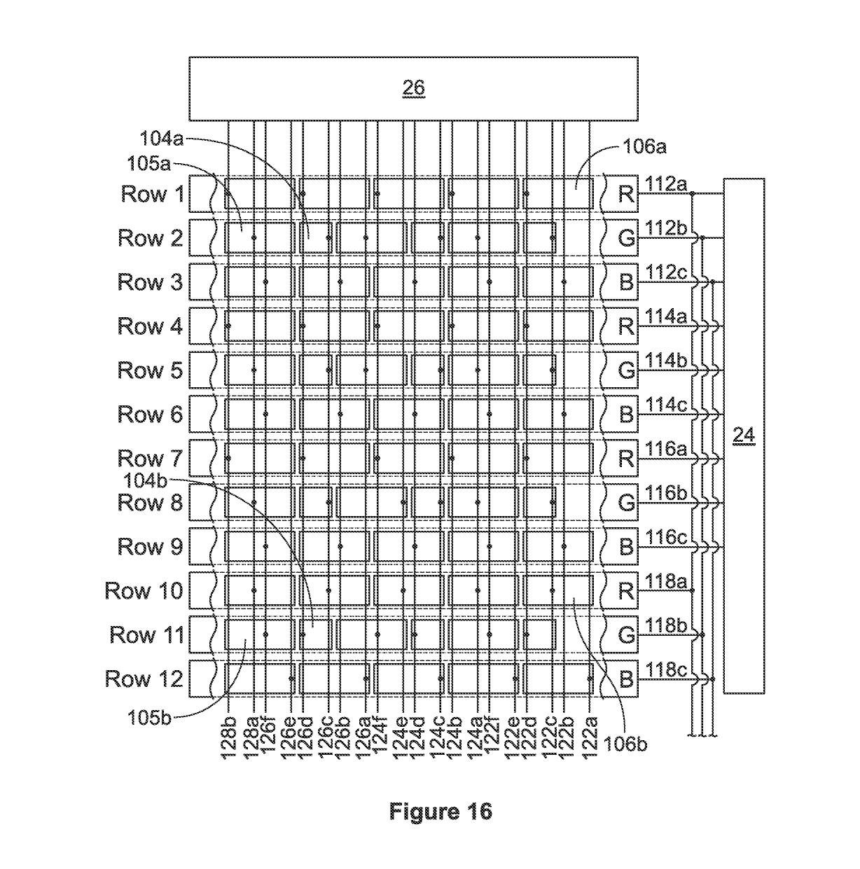

According to some implementations, different color rows of display elements may include display elements with electrodes having different size areas as described above with reference to FIG. 14. When discussing display elements with different size areas, it is understood that the different size areas may come from varying the size of an electrode, as explained with reference to FIG. 15C, or by electrically connecting the electrodes of two adjacent electrodes. For example, colors having less visual importance (such as red and blue) may include fewer independently driven display elements than colors of higher visual importance (such as green). FIG. 16 is a block diagram illustrating examples of a column driver circuit 26 and a row driver circuit 24 for driving an array of display elements 102 including display elements having different size areas in different color rows according to some implementations. The implementation of FIG. 16 has 10 columns and 20 segment lines. As illustrated in FIG. 16, Row 1 having red display elements includes display elements having a larger area, for example, such as display elements with coupled display element segment electrodes as discussed above with reference to FIGS. 15C. As illustrated in FIG. 16, a display element 106a of Row 1 may be configured as two adjacent display elements with display element segment electrodes that are connected to each other. Similarly, Row 3 having blue display elements may also include display elements which have larger areas, for example, such as adjacent display elements having coupled display element segment electrodes. Rows of green display elements, such as Row 2, include display elements having different size areas. For example, Row 2 includes display element 104a which is configured as a display element having a smaller area relative to the display element 106a. The display element 104a may correspond to a display element having a discrete display element segment electrode. Further, Row 2 includes display element 105a having a larger area, which may be configured as two display elements having coupled display element segment electrodes. The array includes shared row driver 24 outputs which are connected to common lines of the same color row for driving the display. In the implementation of FIG. 16, there is a higher linear density of segment electrodes along the green common lines than the blue or red common lines. Thus, there are more independently addressable display elements in the green rows than in the blue and red rows, resulting in more bits per pixel for the green color plane of a displayed image than the red or blue color planes. This allows better display fidelity to the original luminance of the image data, providing a displayed image of visually higher quality, even though there is some penalty in chrominance reproduction

For example, common line 112a is coupled to common line 118a, common line 112b is coupled to common line 118b, and common line 112c is coupled to common line 118c such that data is written simultaneously to Rows 1 and 10 (and although not shown, also rows 19 and 28), Rows 2 and 11 (and, although not shown, also rows 20 and 29), and Rows 3 and 12 (and, although not shown, also rows 21 and 30). Corresponding display elements of the simultaneously addressed rows are connected to different segment lines such that different data may be written to the display elements. For example, display element 106a of Row 1 is connected to segment line 122d, while corresponding display element 106b of Row 10 is connected to segment line 122c. Further, display elements 104a and 105a of Row 2 are connected to segment lines 126c and 128a respectively, while corresponding display elements 104b and 105b of Row 11 are connected to segment lines 126d and 126f respectively. In the configuration of FIG. 16, four rows of red display elements may be addressed simultaneously, 4 rows of blue display elements may be addressed simultaneously, and 3 rows of green may be addressed simultaneously. While not illustrated, common lines of Rows 4 through 9 may also be connected to another common line for writing data simultaneously to those rows. For example, common lines 114a and 116a of Rows 4 and 7 may each be connected to three other common lines connected to rows of red display elements such that four rows of red display elements are addressed simultaneously. For example, in the implementation of FIG. 16, common line 114a of Row 4 may be connected to common lines of Rows 13, 21, and 30 (not shown), while common line 116a of Row 7 may be connected to common lines of Rows 16, 25, and 34 (not shown).

The spacing between rows that have coupled common lines is not limited to the example illustrated in FIG. 16, and may be varied such that common lines of rows that are spaced apart by any number of other rows may be coupled to the same row driver output. In some implementations, it is beneficial to use opposite write polarity outputs from the common driver to write to adjacent rows of the same color. In these implementations, adjacent rows of the same color would not be coupled to the same common driver output (as shown in FIG. 13A, 13B, and 14) nor would common dirver outputs be coupled at a three or other odsd numbered pitch (as shown in FIG. 16). Instead, common driver outputs would be coupled to multiple rows at a pitch of every second row, every fourth row, every sixth row, etc. This allows adjacent rows of the same color to be written with opposite polarity common driver outputs.

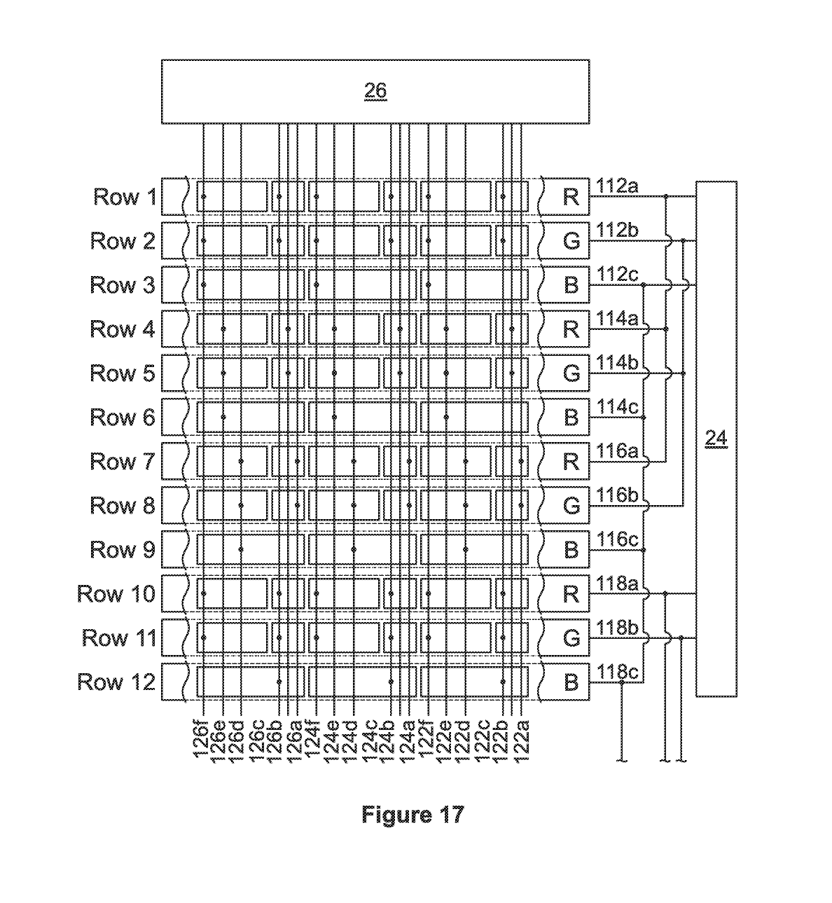

FIG. 17 is a block diagram illustrating another example of a column driver circuit 26 and a row driver circuit 24 for driving an array of display elements 102 including display elements having different areas in different color rows according to some implementations. As illustrated in FIG. 17, rows of red display elements and green display elements may have display elements having a first area and a second area that is larger than the first area. Rows of blue display elements may have a third area that is larger than the first area and the second area. This implementation may be viewed as an implementation of the 3×3 MSB/LSB pixel of FIG. 14, but with only a single bit of blue color depth. In the implementation of FIG. 17, the number of independently addressable display elements in the green rows and red rows is greater than the number of independently addressable display elements in the blue rows once again due to the different linear density of segment electrodes along the different color common lines. In some implementations, the display elements having the third area (e.g., display elements of Rows 3, 6, 9, and 12 as illustrated in FIG. 17) may be configured as three adjacent display elements having coupled display element segment electrodes. In the array of FIG. 17, three rows of red display elements may be addressed simultaneously, three rows of green display elements may be addressed simultaneously, and six rows of blue display elements may be addressed simultaneously.

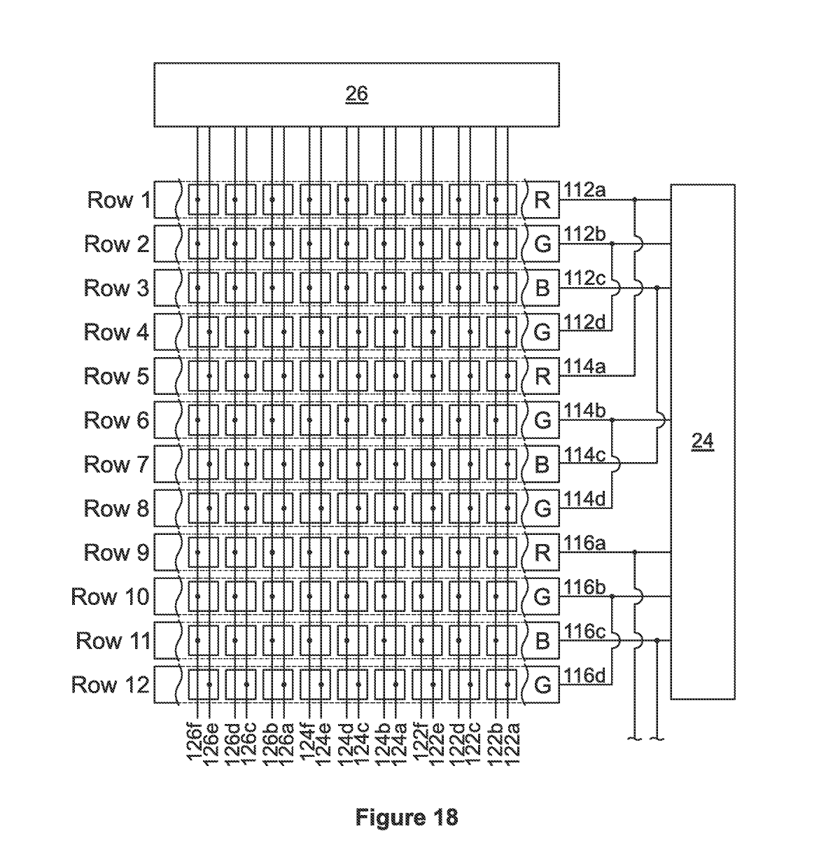

The color pattern of rows of display elements 102 in the array may be configured to include additional rows of colors having a higher visual significance. For example, the array of display elements may include additional rows of green display elements relative to the number of rows of red and blue display elements. FIG. 18 is a block diagram illustrating another example of a column driver circuit 26 and a row driver circuit 24 for driving an array of display elements 102 having a RGBG row pattern of display elements. For example, as illustrated in FIG. 18, the display includes a first row (Row 1) having only red display elements, a second row (Row 2) having only green display elements, a third row (Row 3) having only blue display elements, followed by a fourth row (Row 4) having only green display elements, where the second row is disposed between the first row and the third row and the third row is disposed between the second row and the fourth row. The pattern then repeats such that the rows of the display have a RGBG row pattern. In the RGBG arrangement implementation illustrated, there are twice as many green display elements as there are red display elements, and there are twice as many green display elements as there are blue display elements. In other words, there are as many green display elements as there are red and blue display elements combined. The column driver circuit 26 includes twice as many outputs as columns of display elements. The row driver circuit 24 includes bifurcated outputs, such that two rows having the same color of display elements are driven by a single output of the row driver circuit 24.

In the implementation of FIG. 18, a pixel may be arranged to include more green display elements than blue and red display elements. For example, each pixel may include one red display element in Row 1, two green display elements in Row 2 including a green display element in the same column as the red display element and a green display element that is offset (such as to the right) by one column from the red display element, and one blue display element in Row 3 that is offset (such as to the right) by one column from the red display element in the pixel (herein referred to as a tetris formation). With the tetris RGGB pixel, with M columns of display elements and N rows of display elements, M/2 columns of pixels and N/2 rows of pixels are formed.

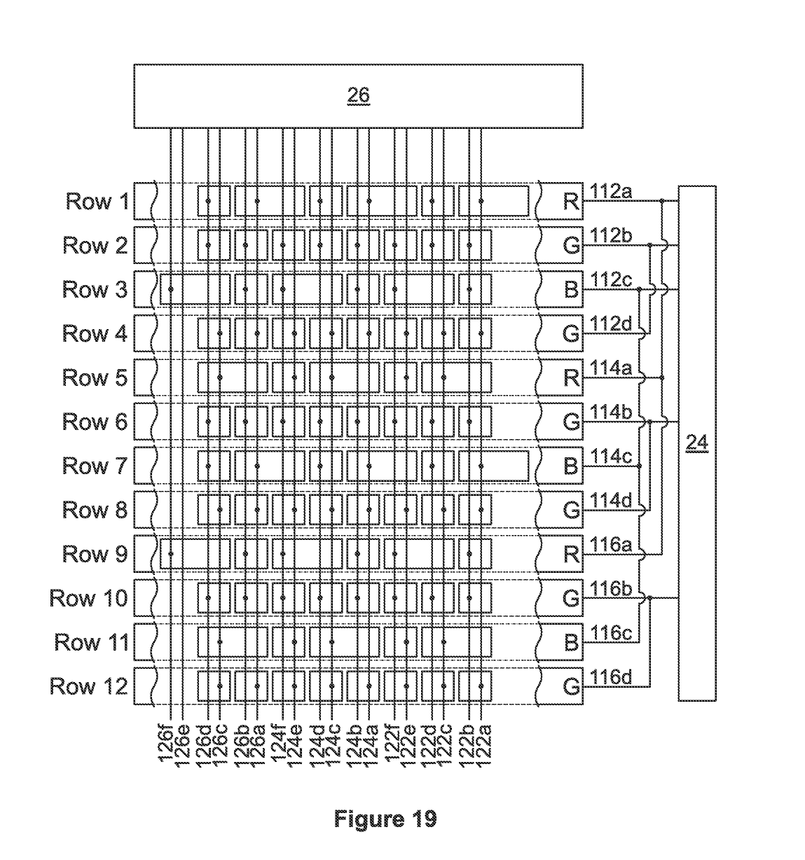

According to some implementations, a RGBG row pattern of display elements may include rows of display elements having different areas, and may also have different color rows offset from one another. FIG. 19 is a block diagram illustrating another example of a column driver circuit 26 and a row driver circuit 24 for driving an array of display elements 102 having a RGBG row pattern. As illustrated in FIG. 19, some of the display elements have different areas than other display elements within the row. As discussed above, different area display elements may be configured as adjacent display elements having coupled display element segment electrodes. Along some rows, display elements may have a first area and a second area that is larger than the first area. In some cases, the rows that include display elements having the second area, or coupled display element segment electrodes, are rows of less visually important colors such as red and blue. As seen in FIG. 19, the green rows include display elements having a first area, with no coupling along the row, maintaining the resolution of the green rows. That is, the resolution of the green rows in the implementation of FIG. 19 is greater in the green rows than in the blue and red rows. Further, as illustrated in FIG. 19, display elements in rows of red display elements (such as Rows 1, 5, and 9 respectively) may be offset relative to each other such that display elements of the same size area not “in-phase” with the corresponding display elements of the other rows. Similarly, display elements in rows of blue display elements (such as Rows 1, 5, and 9 respectively) may be offset relative to each other such that display elements of the same size area not “in-phase” with the corresponding display elements of the other rows. In the example of FIG. 19, three red rows can be addressed simultaneously, three blue rows can be addressed simultaneously, and two green rows can be addressed simultaneously. For a display having a line time that would be updatable at a frame rate of 30 Hz, the display may be updatable at 70 Hz by using the implementation described and illustrated in FIG. 19.

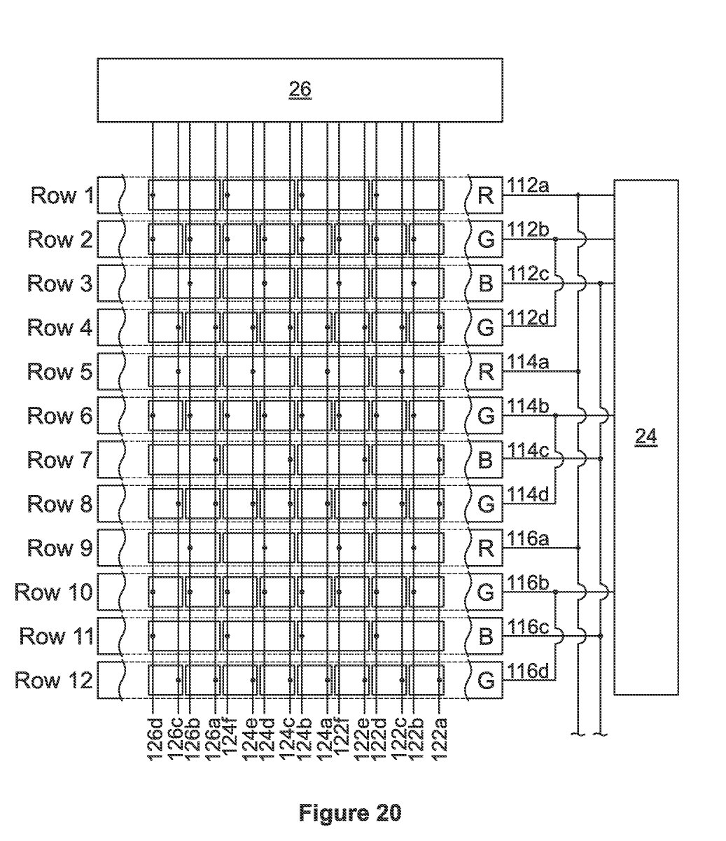

FIG. 20 is a block diagram illustrating another example of a column driver circuit 26 and a row driver circuit 24 for driving an array of display elements 102 having a RGBG row pattern according to some implementations. The array of display elements of FIG. 20 includes green rows of display elements having a first area, and blue and red rows having display elements of a second area that is larger than the first area. In the configuration of FIG. 20, there are more rows of green display elements than rows of blue and red display elements, and there are also more independently addressable green display elements in each green row than red or blue display elements in the red and blue rows. In the array of FIG. 20, two rows of green display elements may be addressed simultaneously, four rows of blue display elements may be addressed simultaneously, and four rows of red display elements may be addressed simultaneously. For a display having a line time that would be updatable at a frame rate of 30 Hz, the display may be updatable at nearly 80 Hz by using the implementation described and illustrated in FIG. 20.

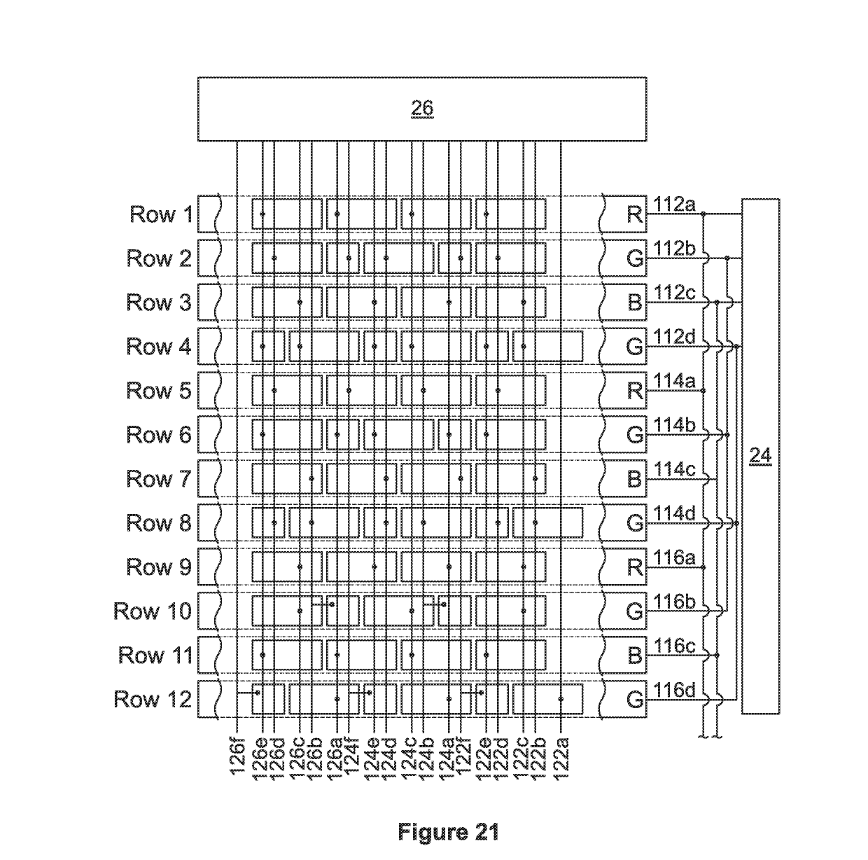

FIG. 21 is a block diagram illustrating another example of a column driver circuit 26 and a row driver circuit 24 for driving an array of display elements 102 having a RGBG row pattern according to some implementations. As illustrated in FIG. 21, the array includes rows of green display elements having a first area and display elements having a second area that is larger than the first area. The array also includes rows of red and blue display elements having the second area. As with FIG. 20, there are more rows of green display elements than rows of blue and red display elements, and there are also more independently addressable green display elements in each green row than red or blue display elements in the red and blue rows. Further, the rows of green display elements of the same size are offset from each other in different rows. For example, as illustrated in FIG. 21, the display elements having the second (larger) area in Row 2 are offset from the same size display elements in Row 4. In some implementations, rows of green display elements that are in phase with each other (e.g., having the same size display elements substantially in line with each other along the segment line direction) are simultaneously addressed. For example, Rows 2, 6 and 10 may have common lines 112b, 114b, and 116b which are coupled to each other and to a single row driver circuit 24 output. Further, in the implementation of FIG. 21, three rows of green display elements may be addressed simultaneously, four rows of red display elements may be addressed simultaneously, and four rows of blue display elements may be addressed simultaneously. For a display having a line time that would be updatable at a frame rate of 30 Hz, the display may be updatable at over 100 Hz by using the implementation described and illustrated in FIG. 21.

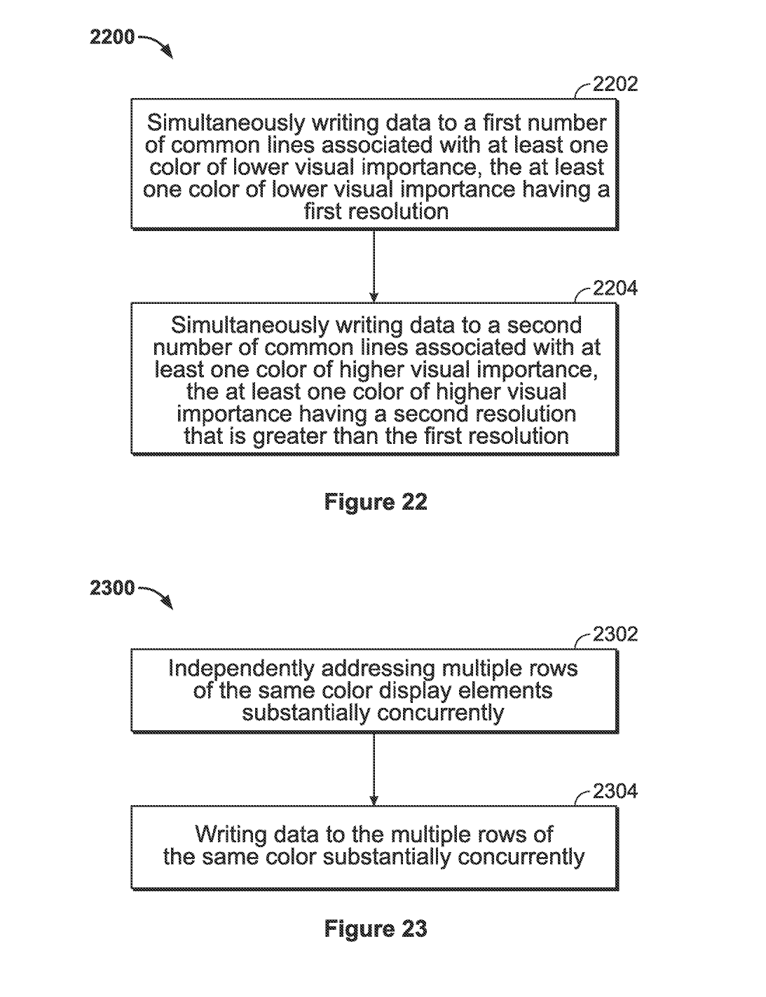

FIG. 22 illustrates a flowchart of a method for writing data to a display according to some implementations. As shown in FIG. 22, the method 2200 includes, during a frame write process, simultaneously writing data to a first number of common lines associated with at least one color of lower visual importance, the at least one color of lower visual importance having a first resolution, as shown in block 2202. For example, the at least one color of lower visual may include blue and red, and the rows of blue and red display elements may include a first number of coupled or electrically connected display element segment electrodes, where more coupled segment electrodes along the common line corresponds to lower “resolution.” The first number, in various implementations, can be a number that is three or greater, or four or greater. Hence, in block 2202, the method includes writing data to multiple common lines simultaneously. The method further includes, during the frame write process, simultaneously writing data to a second number of common lines associated with at least one color of higher visual importance, the at least one color of higher visual importance having a second resolution that is greater than the first resolution, as shown in block 2204. The second number can be, in some implementations, two or greater, or three or greater. In the method, the first number is greater than the second number. Furthermore, in some implementations, the method includes writing the data independently in one or both of blocks 2204, such that the data in a first line of the multiple, simultaneously written lines, is independent of a second line of the multiple, simultaneously written lines.

FIG. 23 illustrates another flowchart of a method for writing data to a display according to some implementations. In this implementations, the display includes M columns of display elements and N rows of display elements, wherein each row is configured with only display elements of one color in a set of colors, there being a greater number of segment lines than columns of display elements. The method includes independently addressing multiple rows of the same color display elements substantially concurrently as shown by block 2302. As shown in block 2304, the method also includes writing data to the multiple rows of the same color substantially concurrently.

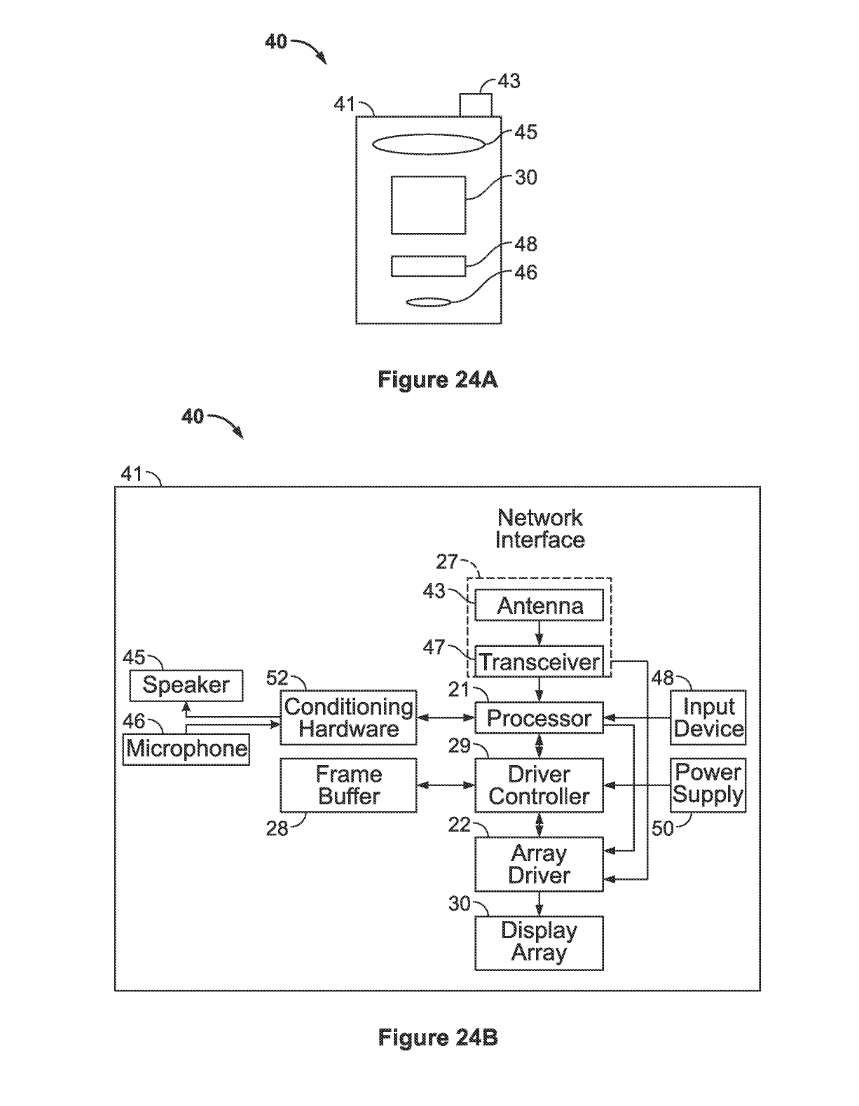

FIGS. 24A and 24B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 24B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11 a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Tenn. Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels. To implement the methods and apparatus described above, the processor and/or the driver controller and/or the array driver format the data to be suitable for driving the array driver to write multiple common lines of data simultaneously, as described, for example, in the above FIGS. 22 and 23. Color information in the data to be displayed can be processed to be compatible with the different numbers of display elements along different color common lines having different visual importance. The array driver can then substantially concurrently drive multiple common lines simultaneously to increase the frame rate.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of increasing the maximum frame rate of a display, the method comprising:
during a frame write process, simultaneously writing data to a first number of common lines associated with at least one color of lower visual importance, the at least one color of lower visual importance having a first resolution; and
during the frame write process, simultaneously writing data to a second number of common lines associated with at least one color of higher visual importance, the at least one color of higher resolution having a second resolution that is greater than the first resolution, wherein the first number is greater than the second number.

2. The method of claim 1, wherein the first number is three or more and the second number is two or more.

3. The method of claim 2, wherein the one or more colors of lower visual importance are one or both of red and blue.

4. The method of claim 3, wherein the one or more colors of higher visual importance includes green.

5. The method of claim 1, comprising writing data to an array of display elements formed at the intersection of a plurality of common lines and segment lines, and wherein writing data comprises passively applying a voltage to display elements connected to the segment lines and the common lines of the array.

6. The method of claim 1, comprising writing different data simultaneously to different common lines.

7. The method of claim 1, comprising:
independently addressing multiple rows of the same color display elements substantially concurrently; and
writing data to the multiple rows of the same color substantially concurrently.

8. A display apparatus comprising:
an array of display elements formed at the intersection of a plurality of common lines and a plurality of segment lines, each display element including a display element segment electrode;
a segment driver connected to the plurality of segment lines; and
a common driver connected to the plurality of common lines;
wherein a first linear density of display element segment electrodes are provided along a first common line,
wherein a second linear density of display element segment electrodes are provided along a second common line, the first linear density being less than the second linear density.

9. The display apparatus of claim 8, wherein the display elements include reflective display elements.

10. The display apparatus of claim 8, wherein the display elements include movable reflective surfaces and static semi-reflective surfaces.

11. The display apparatus of claim 8, wherein a third linear density of display element segment electrodes are provided along a third common line, and wherein the third linear density is different than the second linear density.

12. The display apparatus of claim 11, wherein the third linear density is equal to the first linear density.

13. The display apparatus of claim 8, wherein the common driver has a set of common driver outputs coupled to a set of common electrodes that extend in parallel along a first dimension, the common electrodes connected to the common lines, wherein the number of independently driven common driver outputs is less than the number of common electrodes.

14. The display apparatus of claim 13, wherein the segment driver has a set of segment driver outputs coupled to the display elements segment electrodes, wherein lines of adjacent display elements are formed along each common electrode at locations where a portion of a common electrode is adjacent to a display element segment electrode of the array.

15. The display apparatus of claim 14, wherein,
display elements along the first common line are a first color;
display elements along the second common line are a second color; and
the first color is different than the second color.

16. The display device of claim 15, wherein the second color is green, and wherein the first color is red or blue.

17. The display apparatus of claim 8, wherein the array includes a first row of display elements including only red display elements, a second row of display elements adjacent to the first row and including only green display elements, and a third row of display elements adjacent to the second row and including only blue display elements.

18. The display apparatus of claim 17, wherein the array includes a fourth row of display elements adjacent to the third row and including only green display elements.

19. The display apparatus of claim 8, wherein the segment driver has a plurality of segment driver outputs, there being a greater number of segment driver outputs than columns of display elements, and wherein the segment driver is configured to independently address more than one row of the same color display elements substantially concurrently, and wherein multiple rows of the same color are configured to be driven substantially concurrently by an output of the common driver.

20. The display apparatus of claim 8, further comprising:
a display;
a processor that is configured to communicate with the display, the processor being configured to process image data; and
a memory device that is configured to communicate with the processor.

21. The display apparatus of claim 20, further comprising:
a driver circuit configured to send at least one signal to the display.

22. The display apparatus of claim 21, further comprising:
a controller configured to send at least a portion of the image data to the driver circuit.

23. The display apparatus of claim 20, further comprising:
an image source module configured to send the image data to the processor.

24. The display apparatus of claim 23, wherein the image source module includes at least one of a receiver, transceiver, and transmitter.

25. The display apparatus of claim 20, further comprising:
an input device configured to receive input data and to communicate the input data to the processor.

26. The display apparatus of claim 8, wherein the common dirver and segment driver are configured to passively address the array of display elements.

27. An apparatus for increasing the maximum frame rate of a display, the apparatus comprising:
means for simultaneously writing data to a first number of common lines associated with at least one color of lower visual importance during a frame write process, the at least one color of lower visual importance having a first resolution; and
means for simultaneously writing data to a second number of common lines associated with at least one color of higher visual importance during the frame write process, the at least one color of higher visual importance having a second resolution that is greater than the first resolution,
wherein the first number is greater than the second number.

28. The apparatus of claim 27, wherein the means for simultaneously and independently writing data includes a segment driver connected to a plurality of segment lines a common driver connected to a plurality of common lines.

29. The apparatus of claim 27, wherein the display includes M columns of display elements and N rows of display elements, wherein each row is configured with only display elements of one color in a set of colors, there being a greater number of segment lines than columns of display elements.
